(19) United States
(12) Patent Application Publication
(10) Pub. No.: US 2005/0097208 A1
(43) Pub. Date: May 5, 2005

(54) Node removal using remote back-up system memory

(75) Inventors: Simon C. Chu, Chapel Hill, NC (US); Richard A. Dayan, Raleigh, NC (US); Brandon J. Ellison, Raleigh, NC (US); Eric R. Kern, Durham, NC (US); William B. Schwartz, Apex, NC (US); Adam L. Soderlund, Bahama, NC (US)

Correspondence Address: IBM Corporation;Intellectual Property Law Dept. 9CCA/B002, P.O. Box 12195, Res. Tri. Park, NC, 27709, US

(73) Assignee: International Business Machines Corporation, Armonk, NY (US)

(21) Appl. No.: 10/698,543

(22) Filed: Oct. 31, 2003

(51) Int. Cl. G06F 15/173

(52) U.S. Cl. 709/224

(57) ABSTRACT

A method and system for method of removing a node from a multi-node computer. The node receives a system management interrupt (SMI), resulting in a quiescenting of only that node. The SMI receiving node then polls other nodes in the multi-node computer to determine if the SMI affects an operation of any of the other nodes, and quiescents any other node affected by the SMI. Each quiescent node then transfers all of the contents of its system memory to a backup memory in an unaffected remote node in the multi-node computer. The remote node than assumes the function of the removed node that had received the SMI. The method and system thus allows node removal in the event of a hot-swap request or a predicted failure of a node.

### BACKGROUND OF THE INVENTION

1. Technical Field

The present invention relates in general to the field of computers, and in particular to multi-node computers. Still more particularly, the present invention relates to a method and system for removing a node, or a sub-node, from the multi-node computer after transferring the contents of the node's system memory to a remote node's back-up dynamic memory.

2. Description of the Related Art

A multi-node computer is made up of a multiple nodes, each having its own processor or set of processors. Typically, the multiple nodes work in a coordinated fashion under the direction of a primary supervisory service processor in one of the nodes. An example of a multi-node computer is shown in FIG. 1 as multi-node computer system 100. Each node 106 includes multiple sub-nodes 102. Each sub-node 102 includes a processor 108, which is typically multiple processors acting in a coordinated manner. Each sub-node 102 has two modules of system memory 104, which are volatile memory chips, typically mounted on a either a single in-line memory module (SIMM) or a dual in-line memory module (DIMM). As shown in FIG. 1, these memory modules are assigned to Port 0 and Port 1, and have sequential memory addresses, shown in the example of sub-node 102a as addresses associated with the first two gigabytes of memory (dynamic memory 104a) and the next sequential two gigabytes of memory (dynamic memory 104b).

The system memory configuration shown in FIG. 1 does not provide for redundancy. Thus, if a node 106, a sub-node 102, or even one module of memory 104 should fail, or if a node 106 or sub-node 102 is suddenly taken off line from multi-node computer system 100, the data in the failed/removed node's memory cannot be recovered.

To address the problem of data loss from a dynamic memory failure in a sub-node, FIG. 2 depicts a prior art solution involving local back-up memory. Each node 208 in multi-node computer system 200 includes sub-nodes 202, each having a processor 210. Each sub-node 202 has a primary dynamic memory 204 and a local back-up memory 206, which stores an exact copy of the system memory stored in primary dynamic memory 204, typically using the same memory addresses. Such a system affords some degree of data protection, since failure of either primary dynamic memory 204 or local back-up memory 206 allows a sub-node 202 to continue to operate using the local memory that did not fail. However, if the entire sub-node 202 should fail or be suddenly pulled off-line from multi-node computer system 200, such as in a “hot-swap,” then the data in the failed/removed sub-node 202 is lost to the multi-node computer system 200.

Thus, there is a need for a method and system that permits a removal of a node or sub-node from a multi-node computer system through the retention of system memory data from the node or sub-node being removed, preferably without reducing the total memory size of the multi-node computer system.

### SUMMARY OF THE INVENTION

The present invention is thus directed to a method and system for removing a node from a multi-node computer after retaining, in another node in the multi-node computer, data from the removing node's system memory. The node to be removed receives a system management interrupt (SMI), resulting in a quiescenting of only that node. The SMI receiving node then polls other nodes in the multi-node computer to determine if the SMI affects an operation of any of the other nodes, and quiescents any other node affected by the SMI. Each quiescent node then transfers all of the contents of its system memory to a backup memory in an unaffected remote node in the multi-node computer. The remote node then assumes the function of the removed node that received the SMI. The method and system thus allows node removal in the event of a hot-swap request or a predicted failure of a node.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art multi-node computer system having no system memory dynamic back-up;

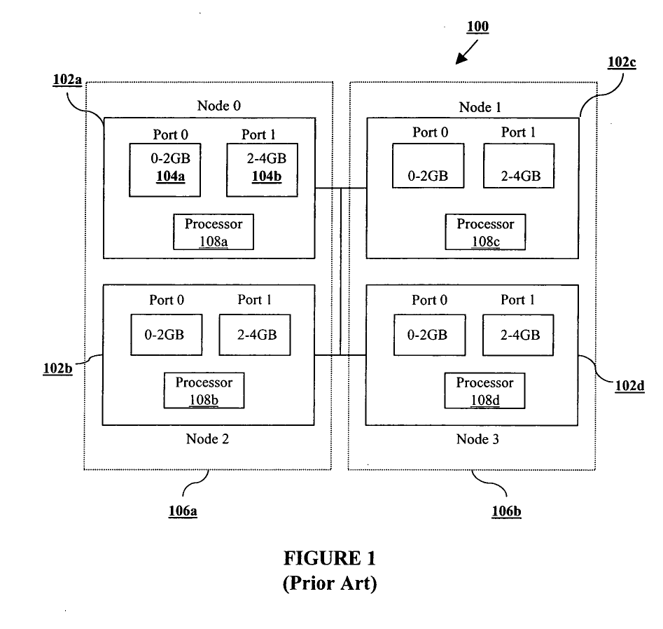

FIG. 2 illustrates a prior art multi-node computer system having local system memory dynamic back-up;

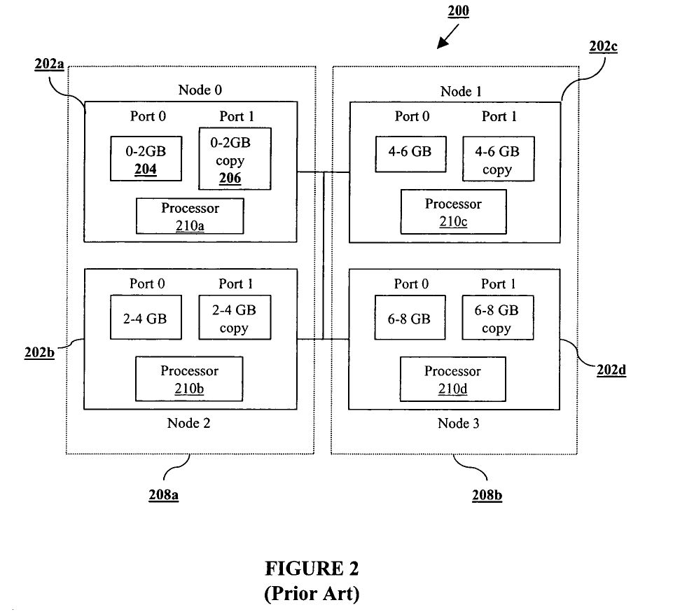

FIG. 3a depicts a preferred embodiment of the inventive multi-node computer system, in which each sub-node in a node has system memory dynamic back-up in a remote sub-node;

FIG. 3b is a flow-chart of storage and use of remote system memory as utilized in one embodiment of the present invention;

FIG. 4 illustrates a preferred embodiment of the inventive multi-node computer system, in which each sub-node has a local system memory dynamic back-up along with buffer interfaces and scalability chipsets that enable movement of a first sub-node's system memory to a back-up dynamic memory in another sub-node, wherein the back-up dynamic memory was previously utilized as a local back-up dynamic memory for the system memory of the second sub-node; and

FIG. 5 is a flow-chart of a removal of a node in the multi-node computer system in response to a system management interrupt (SMI).

### DETAILED DESCRIPTION OF A PREFERRED EMBODIMENT

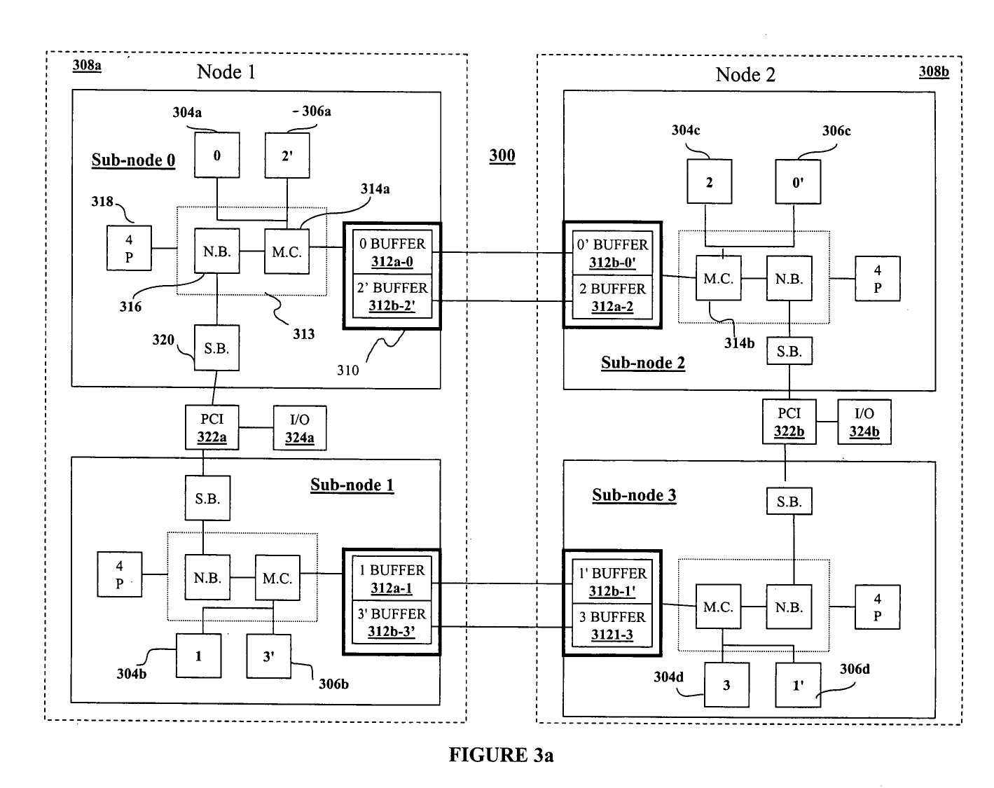

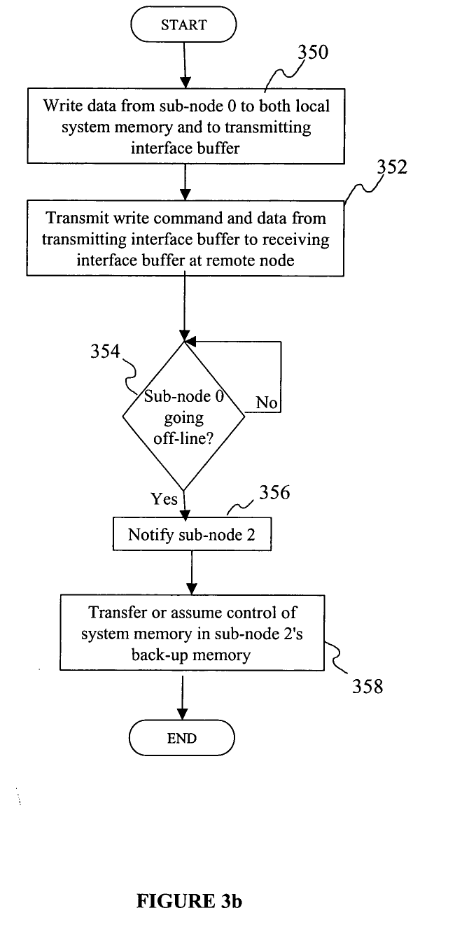

With reference now to FIG. 3a, there is depicted a schematic block diagram of a multi-node computer system 300 according to the present invention. Multi-node computer system 300 has at least two nodes 308, each of which has at least one sub-node. Each node 308 functions as a discrete processing unit, having a shared Peripheral Component Interconnect (PCI) 322 connected to the Southbridge 320 of each sub-node in node 308. Each node 308 includes a scalability chipset 313, which includes a Northbridge 316 connected to the node's Southbridge 320. Connected to scalability chipset 313 is processor 318, preferably multiple processors, and scalability port 310, about which more is discussed below.

Also within scalability chipset 313 is a memory controller 314, which controls multiple volatile memories, such as primary volatile memory 304 and back-up volatile memory 306. Primary volatile memory 304, preferably in a Single In-Line Memory Module (SIMM) or a Dual In-Line Memory Module (DIMM), holds the system memory for processor 318 in the sub-node. Back-up volatile memory 306 is a back-up memory for a system memory used in a remote node/sub-node. For example, in FIG. 3a, back-up volatile memory 306a contains a back-up copy of sub-node 2's system memory that is contained in volatile memory 304c. Similarly, sub-node 0's system memory, whose original copy is stored in volatile memory 304a, has a back-up copy stored remotely in back-up volatile memory 306c. Note that in a preferred embodiment of the present invention, local and back-up system memories are arranged such that if an entire node should go down, no system memories are lost. Thus in FIG. 3a, node 308b contains local system memories in sub-nodes 2 and 3, as well as back-up copies of system memories for sub-nodes 0 and 1 of node 308a.

Alternatively, the location and placement of back-up copies of system memories is dependent on an affinity one node has for another. This affinity may be determined by shared system memories, common or related processes, or other factors that make two nodes or sub-nodes closely aligned. Thus if sub-node 0 is running a process that utilizes common data as a process running in sub-node 2, then the back-up copy of sub-node 0's system memory is stored in sub-node 2, which allows sub-node 2 to be able to access and use the back-up copy of sub-node 0's system memory, assuming memory coherence is not an issue or is addressed in some other manner.

Back-up copies of system memory are under the control of memory controllers 314. In a preferred embodiment of the present invention, every time a write is made to a local primary volatile memory 304, a corresponding write is made to a remote back-up volatile memory 306. For example, when a write is made to the system memory in volatile memory 304a in sub-node 0, a back-up write is also made to the back-up volatile memory 306c in sub-node 2. To perform the back-up write, memory controller 314a sends a write command with data to both local volatile memory 304a as well as to a sending interface buffer 312a-0. Sending interface buffer 312a-0, which preferably is a write-through cache, sends the write command and data to a receiving interface buffer 312b-0′, which forwards the write command and data to memory controller 314b in sub-node 2. Memory controller 314b sends the write command and data to back-up volatile memory 306c, which thus keeps an updated copy of the system memory of sub-node 0. Note that as long as sub-node 0 is functioning normally and is on-line, the back-up system memory in back-up volatile memory 306c is not used by any system.

Likewise, whenever memory controller 314b sends a write command to primary volatile memory 304c updating the system memory of sub-node 2, a write command and the data update is sent by memory controller 314b to back-up volatile memory 306a via a sending interface buffer 312a-2 and a receiving interface buffer 312b-2′. Thus, back-up volatile memory 306a contains a valid current copy of sub-node 2's system memory.

PCI 322 is a common interface for input/output (I/O) 324 for two sub-nodes as long as both sub-nodes are on-line. For example, PCI 322a and I/O 324a provide an input/output interface for both sub-node 0 and sub-node 1 as long as sub-node 0 and sub-node 1 are operating normally in node 308a. However, if sub-node 0 should be removed, such as in the event of a failure of sub-node 0, then PIC 322a and I/O 324a provide an input/output interface to only sub-node 1.

FIG. 3b is a flow-chart describing the storage and use of remote back-up system memory utilizing the exemplary system shown in FIG. 3a. Whenever data is written to system memory in a first sub-node such as sub-node 0, the data is also written to the transmitting interface buffer (block 350). The write command and data are then transmitted from the transmitting interface buffer to a receiving interface buffer located on a remote sub-node of a remote node (block 352). As long as the first sub-node remains on-line with the multi-node computer, no further steps are taken, assuming that there are no new writes to system memory in the first sub-node (block 354). However, if the first sub-node should fail or otherwise go off-line from the multi-node computer, then remote sub-node 2 is so notified (block 356). The remote sub-node then either takes over the role of sub-node 0 by making the back-up memory in the remote sub-node 2 its primary system memory, or else the remote sub-node 2 transfers its back-up memory containing sub-node 0's system memory to another active sub-node's primary system memory, which allows that sub-node to assume the role, function and identity of the failed sub-node 0 (block 358).

The system and method described in FIGS. 3a-b thus incorporate the concept of having an up-to-date copy of system memory in a remote sub-node at all times, allowing the first local sub-node to be removed if the first local sub-node fails or is re-allocated to another node or similar subsystem. Similarly, if an entire node is to be removed from a system, then all sub-nodes' role, identity and function is assumed by other remote sub-nodes, thus permitting “hot-swapping” of nodes in and out of systems.

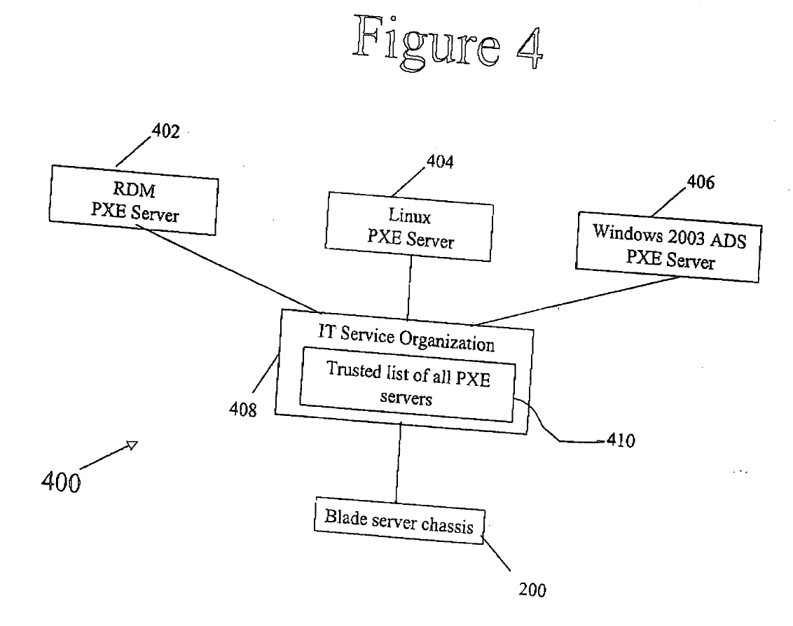

To avoid the expense of monitoring and controlling where (in which remote sub-node) a local sub-node's system memory is backed up, the present invention also contemplates local system memory back-up. Local system memory back-up affords faster system memory writes and reads, as the data does not have to pass through local and remote interface buffers, and the data is touched only once by the local memory manager. Thus, FIG. 4 illustrates a multi-node computer system 400 having multiple nodes 408, each having at least one sub-node 402. Sub-nodes 402 each have a dynamic memory 404 for storing an active system memory data, plus a local back-up memory 406 for storing a back-up copy of the sub-node's system memory. Each sub-node also has a scalability port 410, having interface buffers 412, a memory controller that controls contemporaneous reads/writes to both dynamic memory 404 and local back-up memory 406, as well as a Northbridge 416, processor(s) 418, and a PCI interface 422 with an I/O 424.

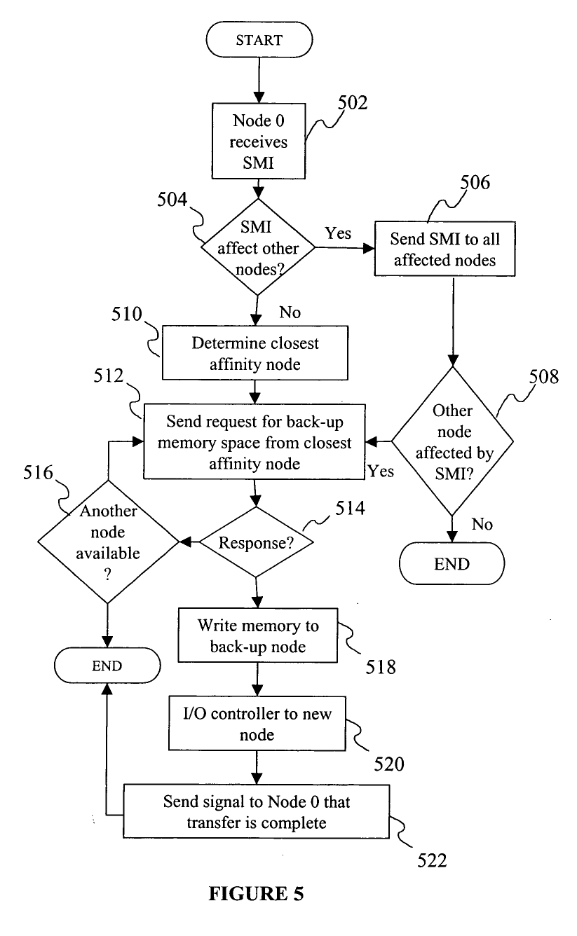

In the event of a failure of dynamic memory 404 or local back-up memory 406, the sub-node 402 may continue to operate normally, since a valid copy of system memory is still available. However, if both dynamic memory 404 and local back-up memory 406 fail, then there is a complete failure of the sub-node 402 housing the failed memories. In either event, the failed/failing sub-node can appropriate a remote back-up memory from another sub-node. Particularly, if both memories are failing, or are both predicted to fail, then the system memory of the sub-node housing the failing memories must be transferred to a remote sub-node. For example, if there is a prediction that dynamic memory 404a and local back-up memory 406a are about to fail, or sub-node 0 is about to fail for some other reason (such as a power failure, processor failure, bus failure, etc.), then the system memory stored in either dynamic memory 404a or local back-up memory 406a (assuming both memories contain valid copies of the system memory currently in use by sub-node 0), is sent to a remote sub-node such as sub-node 2. In this case, the system memory is sent to back-up dynamic memory 406c by over-writing the back-up system memory for sub-node 2. FIG. 5 illustrates such a process.

Starting at block 502, assume that sub-node 0 develops or receives a system management interrupt (SMI). A query (query block 504) is sent out asking if there are any other nodes or sub-nodes that are or may be affected by the SMI. If so (block 506), the SMI is sent to all possibly affected nodes/sub-nodes, and the other node/sub-node is affected (block 508) those nodes/sub-nodes follow the process followed by the first node/sub-node. Returning to query block 504, the first sub-node 0 determines which node or sub-node has a close affinity to sub-node 0. This affinity may be due to similar process priorities, similar data used/manipulated, or physical proximity between nodes/sub-nodes. Alternately, a sub-node may be chosen because it does NOT have an affinity with sub-node 0, particularly if sub-node 0 and the other sub-node are within the same node, which may have a higher likelihood of total failure if one of its sub-nodes fails.

Looking now to block 512, once another sub-node is selected, a request is sent from sub-node 0 requesting permission to appropriate (commandeer) the back-up dynamic memory 406 of a remote sub-node, such as sub-node 2. If sub-node 2 agrees to donate its back-up dynamic memory 406c to sub-node 0 (query block 514), then the writing of sub-node 0's system memory to back-up dynamic memory 406c begins (block 518). Otherwise, another sub-node is asked (query block 516) until some sub-node donates its back-up dynamic memory, or else the back-up fails (end). The granting of permission to sub-node 0 to appropriate the back-up dynamic memory 406c is preferably under the control and direction of memory controller 414c in sub-node 2, although a remote system manager may make this decision.

Once the system memory from sub-node 0 is written to back-up dynamic memory 406c, sub-node 2's I/O 424c is configured to be the I/O for processes previously communicated to sub-node 0 (block 520). A message is then sent from sub-node 2 to sub-node 0 indicating that the system memory transfer is complete (block 522), along with the transfer of the location identity (for I/O purposes) of sub-node 0.

The present invention therefore provides a method and system for allowing a node/sub-node to be removed from a multi-node computer system, because of a node failure, a volitional election to re-allocate the node/sub-node to another task, or a volitional removal of the node/sub-node for maintenance or other elections.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

1. A service for removing a node from a multi-node computer, the service comprising:
receiving a system management interrupt (SMI) in a node in a multi-node computer;
quiescenting only the node receiving the SMI;
polling other nodes in the multi-node computer to determine if the SMI affects an operation of any of the other nodes;
quiescenting any other SMI affected node; and
transferring all of the contents of any affected node's system memory to a backup memory in an unaffected node in the multi-node computer, wherein the unaffected node assumes all operations of the node that received the SMI, thus allowing the node to be removed from the multi-node computer.

2. The service of claim 1, wherein the SMI is in response to a request to hot-swap out the node.

3. The service of claim 1, wherein the SMI is in response to a predicted failure of the node.
